(19) United States
(12) Patent Application Publication
(10) Pub. No.: US 2024/0416855 A1
(43) Pub. Date: Dec. 19, 2024

(54) VEHICLE BASED EXTERNAL POWER AND REMOTE AUTHORIZATION CONTROL SYSTEM

(71) Applicant: Ford Global Technologies, LLC, Dearborn, MI (US)

(72) Inventors: Stuart C. Salter, White Lake, MI (US); Vyas Darshan Shenoy, Canton, MI (US); Brendan Diamond, Grosse Pointe, MI (US); Todd Ansbacher, Westland, MI (US); David Celinske, Wolverine Lake, MI (US)

(73) Assignee: Ford Global Technologies, LLC, Dearborn, MI (US)

(21) Appl. No.: 18/333,984

(22) Filed: Jun. 13, 2023

(51) Int. Cl. B60R 16/033

(52) U.S. Cl. CPC B60R 16/033

(57) ABSTRACT

A vehicle having a vehicle power system is disclosed. The vehicle may include a battery and the vehicle power system configured to transfer power from the battery to an external accessory connected to the vehicle power system. The vehicle may further include a processor configured to obtain a vehicle power system usage rule set or a vehicle power system usage request from a user device associated with a user to use the vehicle power system, via a wireless communication network. The processor may be further configured to control a vehicle power system operation based on the vehicle power system usage rule set or the vehicle power system usage request.

### FIELD

The present disclosure relates to a vehicle based external power system and more particularly to systems and methods for facilitating remote authorization of vehicle based external power system usage.

### BACKGROUND

Modern vehicles have external power systems to power auxiliary accessories, such as compressors, saws, electronic devices, etc. For example, some modern vehicles have power take-off (PTO), electric PTO (ePTO), etc. that facilitates powering of auxiliary accessories. A PTO transfers mechanical power from a vehicle engine to an accessory that may not have its own engine or motor to operate. A vehicle operator may need to ensure that the vehicle engine is operational for the PTO to transfer mechanical power to the accessory.

The ePTO decouples auxiliary functions, such as powering accessories, from vehicle engine usage. Stated another way, the ePTO enables the vehicle operator to power accessories even when the vehicle engine may not be operational. The ePTO may include an inverter and an electric motor powered by a DC power source, such as a battery, which may be used to power the accessories.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example of an environment in which techniques and structures for providing the systems and methods disclosed herein may be implemented.

FIG. 2 depicts a block diagram of an example of a system to facilitate remote authorization of a vehicle power system in accordance with the present disclosure.

FIG. 3 depicts an example of an embodiment to control vehicle power system operation in accordance with the present disclosure.

FIG. 4 depicts an example of an embodiment to control vehicle power system operation in accordance with the present disclosure.

FIG. 5 depicts a flow diagram of an example of a first method to facilitate remote authorization of a vehicle power system in accordance with the present disclosure.

FIG. 6 depicts a flow diagram of an example of a second method to facilitate remote authorization of a vehicle power system in accordance with the present disclosure.

### DETAILED DESCRIPTION

### Overview

The present disclosure describes power management systems and methods to facilitate remote authorization of vehicle based external power system usage. The power management system may include a vehicle power system that may be disposed in a vehicle. The vehicle power system may be an electric power take-off (ePTO) that may be configured to transfer power from a vehicle battery to an external accessory (e.g., power tools, lighting devices, etc.). The power management system may further include a processor that may be configured to obtain a vehicle power system usage request or a vehicle power system usage rule set to use/control the vehicle power system. The processor may be further configured to control vehicle power system operation based on the vehicle power system usage request or the vehicle power system usage rule set. For example, the processor may activate or deactivate the vehicle power system or limit discharge rates based on the vehicle power system usage request or the vehicle power system usage rule set.

In some aspects, the vehicle power system usage rule set may include one or more conditions/criteria to control the vehicle power system operation. For example, the vehicle power system usage rule set may include at least one of: a rule set to activate the vehicle power system for a predefined time duration, a rule set to activate the vehicle power system between a first timestamp and a second timestamp, a rule set to activate the vehicle power system for a predefined threshold energy usage value, a rule set to activate the vehicle power system in a vehicle predefined geofenced area, and/or the like.

In some aspects, the processor may be further configured to obtain inputs from vehicle cameras (or vehicle sensors) when the vehicle power system may be activated and monitor the vehicle power system usage based on the obtained inputs. Based on the monitoring, the processor may be configured to determine vehicle power system improper usage. Responsive to a determination that the vehicle power system may be improperly used, the processor may deactivate the vehicle power system.

In further aspects, the processor may be configured to obtain another vehicle power system usage request from a third party user device. The other vehicle power system usage request may include request details such as information associated with a vehicle power system outlet to be used, a time duration to use the outlet, information associated with the external accessory to be powered by using the vehicle power system, and an expected power consumption. Responsive to obtaining the request, the processor may correlate the other vehicle power system usage request with the vehicle power system usage rule set and may control the vehicle power system operation based on the correlation.

The present disclosure discloses system and method to facilitate remote monitoring and controlling of the vehicle power system. The system prevents vehicle power system misuse. The system further enables a vehicle owner to provide remote authorization to activate or deactivate the vehicle power system. Stated another way, the system enables the vehicle owner to control or use the vehicle power system via a wireless network. The system further facilitates a third party to use the vehicle power system when a vehicle owner may be away from the vehicle.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

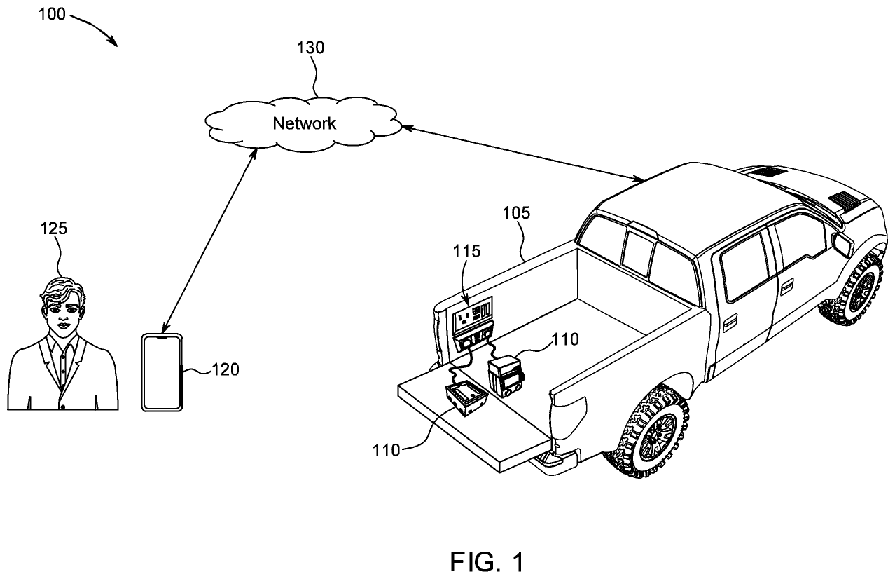

FIG. 1 depicts an example of an environment 100 in which techniques and structures for providing the systems and methods disclosed herein may be implemented. The environment 100 may include a vehicle 105 that may be a truck, a van, a truck trailer, and/or the like. The vehicle 105 may include any powertrain, such as, for example, a gasoline engine, one or more electrically-actuated motor(s), a hybrid system, etc. Furthermore, the vehicle 105 may be a manually driven vehicle and/or be configured and/or programmed to operate in a fully autonomous (e.g., driverless) mode (e.g., Level-5 autonomy) or in one or more partial autonomy modes which may include driver assist technologies.

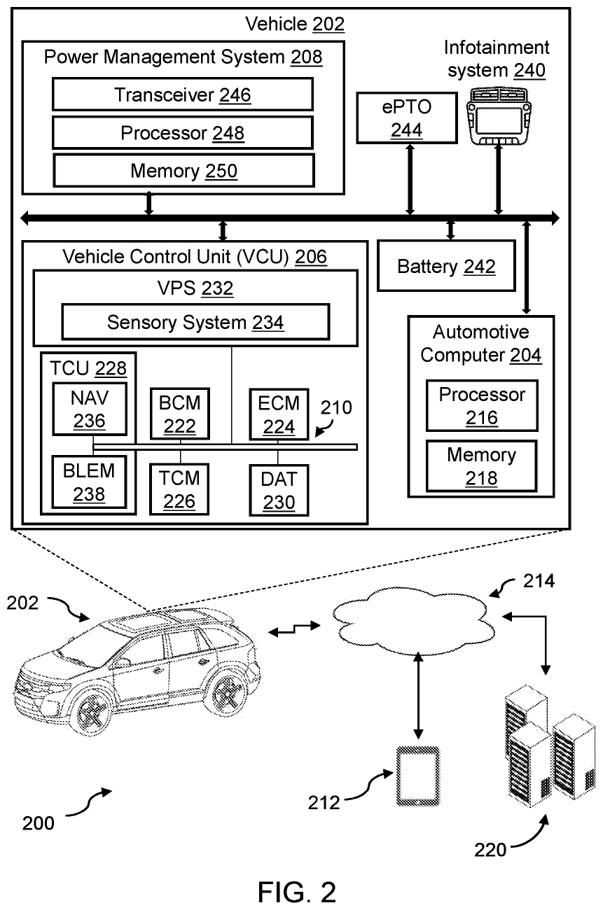

The vehicle 105 may include a vehicle power system (shown as electric power takeoff 244 in FIG. 2) that may be configured to provide/supply power to an external accessory 110. In some aspects, the vehicle power system may be an electric power takeoff (ePTO) that may be configured to transfer power from a battery (shown as battery 242 in FIG. 2) to the accessory 110. The battery may be disposed in the vehicle 105. The accessory 110 may include, but not limited to, a plasma cutter, a TIG welder, a chop saw, an air compressor, an angle grinder, a jackhammer, a projector, loudspeakers, lighting devices, cement mixers, a mini fridge, and/or the like. The vehicle power system may include one or more electrical outlets 115 or any type of hardwired connection, such as a fixed hardwired connection, between the vehicle power system and the accessory 110. In some aspects, the outlets 115 may be disposed in proximity to a vehicle cargo bed or a vehicle tailgate, as depicted in FIG. 1.

The environment 100 may further include a user device 120 that may be associated with a user 125. The user 125 may be associated with the vehicle 105 and may include a vehicle manager, a fleet manager, or a vehicle owner. The user device 120 may include a mobile device, a tablet, a laptop, a smart watch, or any other device with communication capabilities. The vehicle 105 and the user device 120 may communicatively couple with each other via one or more networks 130.

The network(s) 130 illustrates an example of a communication infrastructure in which the connected devices discussed in various embodiments of this disclosure may communicate. The network(s) 130 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 105 may include a vehicle power management system (shown as power management system 208 in FIG. 2) configured to control vehicle power system operation. Specifically, the vehicle power management system (“system”) may be configured to receive request or inputs from the user device 120 via the network 130 and control the vehicle power system operation based on the received request or inputs. For example, the system may receive a request to activate or deactivate the vehicle power system from the user 125 (wirelessly via the user device 120) who may be located away from the vehicle 105. Stated another way, the user 125 may be configured to remotely or wirelessly monitor and control activation or deactivation of the vehicle power system via the user device 120 and the network 130.

In some aspects, the inputs received from the user device 120 may include a rule set including predetermined conditions/criteria that may facilitate the system to control vehicle power system operation or usage. For example, the system may receive a rule set to activate or deactivate a specific outlet associated with the vehicle power system, limit/control discharge rate associated with the vehicle power system, activate the vehicle power system between a first timestamp (e.g., 9 AM) and a second timestamp (e.g., 5 PM), activate the vehicle power system for a predefined time duration (e.g., 4 hours), activate the vehicle power system for a first predefined threshold energy usage value, activate the vehicle power system in a vehicle predefined geofenced area, and/or the like.

The vehicle 105 and/or the vehicle operator/user may implement and/or perform operations, as described here in the present disclosure, in accordance with the owner manual and safety guidelines.

Functions details of the vehicle power management system are described below in conjunction with FIG. 2.

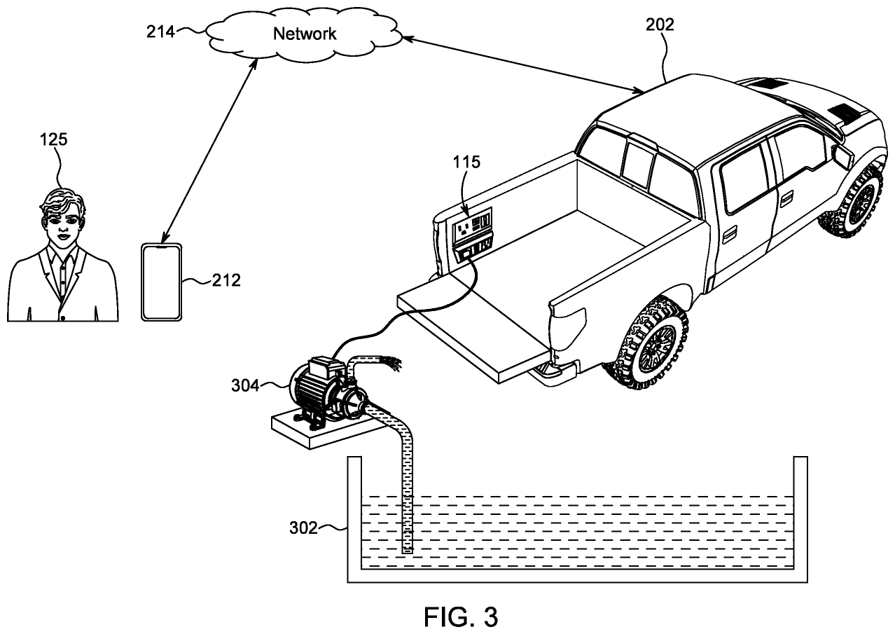

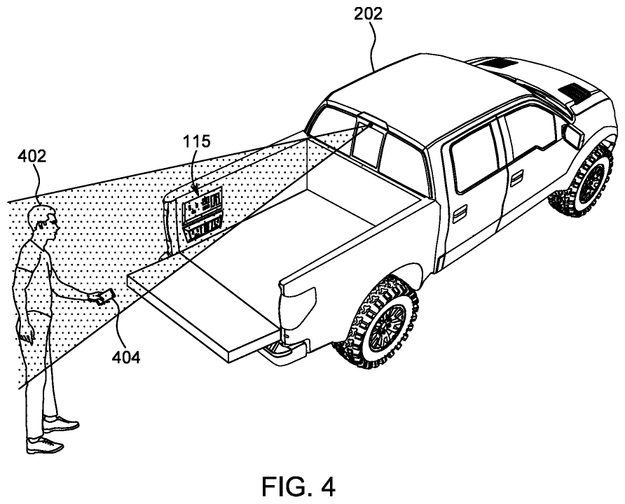

FIG. 2 depicts a block diagram of an example of a system 200 to facilitate remote authorization of a vehicle power system in accordance with the present disclosure. While describing FIG. 2, references may be made to FIGS. 3 and 4.

The system 200 may include a vehicle 202, which may be same as the vehicle 105. The vehicle 202 may include an automotive computer 204, a Vehicle Control Unit (VCU) 206, and a vehicle power management system 208 (or a power management system 208, same as the vehicle power management system described in conjunction with FIG. 1). The VCU 206 may include a plurality of Electronic Control Units (ECUs) 210 disposed in communication with the automotive computer 204.

The system 200 may further include a mobile device 212 or a user device 212 that may connect with the automotive computer 204 and/or the vehicle power management system 208 by using wired and/or wireless communication protocols and transceivers. In some aspects, the mobile device 212 may be associated with the user 125. The mobile device 212 may communicatively couple with the vehicle 202 via one or more network(s) 214. The network 214 may be same as the network 130.

In some aspects, the automotive computer 204 and/or the vehicle power management system 208 may be installed in a vehicle engine compartment (or elsewhere in the vehicle 202), in accordance with the disclosure. Further, the automotive computer 204 may operate as a functional part of the vehicle power management system 208. The automotive computer 204 may be or include an electronic vehicle controller having one or more processor(s) 216 and a memory 218. Moreover, the vehicle power management system 208 may be separate from the automotive computer 204 (as shown in FIG. 2) or may be integrated as part of the automotive computer 204.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable memory storing a vehicle power management program code. The memory 218 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

In some aspects, the automotive computer 204 and/or the vehicle power management system 208 may be disposed in communication with one or more server(s) 220 and the mobile device 212 via the network 214. In some aspects, the server(s) 220 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet.

In accordance with some aspects, the VCU 206 may share a power bus with the automotive computer 204 and may be configured and/or programmed to coordinate the data between vehicle 202 systems, connected servers (e.g., the server(s) 220), and other vehicles (not shown in FIG. 2) operating as part of a vehicle fleet. The VCU 206 can include or communicate with any combination of the ECUs 210, such as, for example, a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 206 may further include and/or communicate with a Vehicle Perception System (VPS) 232, having connectivity with and/or control of one or more vehicle sensory system(s) 234. The vehicle sensory system 234 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (LiDAR or “lidar”) sensor, door sensors, proximity sensors, temperature sensors, weight sensors, vehicle wheel sensors, vehicle internal or external cameras, vehicle external power usage sensors, etc. In some aspects, the vehicle external power usage sensors may be configured to detect vehicle power system usage such as an amount of energy drawn, a time duration for which the energy may be drawn, a rate at which the energy may be drawn, etc.

In some aspects, the VCU 206 may control vehicle 202 operational aspects and implement one or more instruction sets received from the mobile device 212, from one or more instruction sets stored in computer memory 218 of the automotive computer 204, including instructions operational as part of the vehicle power management system 208.

The TCU 228 can be configured and/or programmed to provide vehicle connectivity to wireless computing systems onboard and off board the vehicle 202, and may include a Navigation (NAV) receiver 236 for receiving and processing a GPS signal, a BLE® Module (BLEM) 238, a Wi-Fi transceiver, a UWB transceiver, and/or other wireless transceivers (not shown in FIG. 2) that may be configurable for wireless communication between the vehicle 202 and other systems (e.g., a vehicle key fob, not shown in FIG. 2), computers, and modules. The TCU 228 may be disposed in communication with the ECUs 210 by way of a bus.

The ECUs 210 may control aspects of vehicle operation and communication using inputs from human drivers, inputs from an autonomous vehicle controller, the vehicle power management system 208, and/or via wireless signal inputs received via the wireless connection(s) from other connected devices, such as the mobile device 212, the server(s) 220, among others.

The BCM 222 generally includes integration of sensors, vehicle performance indicators, and variable reactors associated with vehicle systems, and may include processor-based power distribution circuitry that can control functions associated with the vehicle body such as lights, windows, security, camera(s), audio system(s), speakers, door locks and access control (including vehicle power system control), and various comfort controls. The BCM 222 may also operate as a gateway for bus and network interfaces to interact with remote ECUs (not shown in FIG. 2).

The DAT controller 230 may provide Level-1 through Level-3 automated driving and driver assistance functionality that can include, for example, active parking assistance, vehicle backup assistance, adaptive cruise control, and/or lane keeping, among other features. The DAT controller 230 may also provide aspects of user and environmental inputs usable for user authentication.

In some aspects, the automotive computer 204 may connect with an infotainment system 240 that may include a touchscreen interface portion and may include voice recognition features, biometric identification capabilities that can identify users based on facial recognition, voice recognition, fingerprint identification, or other biological identification means. In other aspects, the infotainment system 240 may be further configured to receive user instructions via the touchscreen interface portion and/or display notifications, navigation maps, etc. on the touchscreen interface portion.

The computing system architecture of the automotive computer 204, the VCU 206, and/or the vehicle power management system 208 may omit certain computing modules. It should be readily understood that the computing environment depicted in FIG. 2 is an example of a possible implementation according to the present disclosure, and thus, it should not be considered limiting or exclusive.

The vehicle 202 may further include a battery 242 configured to store power. The vehicle 202 may additionally include an electric power takeoff (ePTO) 244 (or a vehicle power system 244) configured to transfer power from the battery 242 to an external accessory. The external accessory may be same as the accessory 110 described in conjunction with FIG. 1. In some aspects, the ePTO 244 may include an inverter and an electric motor (not shown) that may be powered by the battery 242.

In accordance with some aspects, the vehicle power management system 208 may be integrated with and/or executed as part of the ECUs 210. The vehicle power management system 208, regardless of whether it is integrated with the automotive computer 204 or the ECUs 210 or whether it operates as an independent computing system in the vehicle 202, may include a transceiver 246, a processor 248, and a computer-readable memory 250.

The transceiver 246 may be configured to receive information/inputs from one or more external devices or systems, e.g., the mobile device 212, the server(s) 220, and/or the like via the network 214. For example, the transceiver 246 may be configured to receive a user request and/or user inputs/instructions wirelessly from the mobile device 212 (directly or via the server 220) to control the vehicle power system 244. In some aspects, the user inputs may include rule sets to control vehicle power system operation. For example, the rule sets may include rule sets to activate or deactivate a specific outlet associated with the vehicle power system 244, limit/control discharge rate associated with the vehicle power system 244, activate the vehicle power system 244 between a first timestamp (e.g., 9 AM) and a second timestamp (e.g., 5 PM), activate the vehicle power system 244 for a predefined time duration (e.g., 4 or 5 hours), activate the vehicle power system 244 for a first predefined threshold energy usage value, and activate the vehicle power system 244 in a vehicle predefined geofenced area, and/or the like. In some aspects, the transceiver 246 may be configured to store the received user inputs/instructions in the memory 250.

Further, the transceiver 246 may transmit notifications (e.g., alert/alarm signals) or information to the external devices or systems. In addition, the transceiver 246 may be configured to receive information/inputs from vehicle 202 components such as the infotainment system 240, the vehicle sensory system 234, and/or the like. Further, the transceiver 246 may transmit notifications (e.g., alert/alarm signals) to the vehicle 202 components such as the infotainment system 240.

The processor 248 and the memory 250 may be same as or similar to the processor 216 and the memory 218, respectively. Specifically, the processor 248 may utilize the memory 250 to store programs in code and/or to store data for performing aspects in accordance with the disclosure. The memory 250 may be a non-transitory computer-readable memory storing the vehicle power management program code.

In addition to the user inputs, the memory 250 may be configured to store details of users (“authorized users,” including the user 125) who may be authorized to operate the vehicle 202 and/or the vehicle power system 244. For example, the memory 250 may store authorized user images (such as images of employees of a fleet operating firm that may own the vehicle 202), details associated with user devices associated with the authorized users (including the user device 120), and/or the like. The memory 250 may further store details associated with power consumption rate and/or capacity (or expected power consumption rate) of different accessories that may be connected with the vehicle power system 244 to draw power.

In operation, the processor 248 may be configured to obtain a user request remotely from the mobile device 212 to control vehicle power system operation. In some aspects, the processor 248 may obtain the user request via the transceiver 246 and the network 214. The user request may include at least one of: a request to activate or deactivate the vehicle power system 244, a request to activate or deactivate an outlet (such as the outlet 115) associated with the vehicle power system 244, and a request to limit discharge rate associated with the vehicle power system 244. Responsive to obtaining the user request, the processor 248 may be configured to control vehicle power system 244 operation based on the user request. In this manner, the processor 248 may be configured to provide remote authorization to the user 125 (via the mobile device 212) to control the vehicle power system 244. The aspect of remote authorization may be understood in conjunction with FIG. 3.

Specifically, FIG. 3 depicts an example of an embodiment to control the vehicle power system 244 in accordance with the present disclosure. In the exemplary aspect depicted in FIG. 3, the user 125 may be using the vehicle 202 (specifically the vehicle power system 244) to drain/draw water from a pool 302, via a motor 304. The motor 304 may be an external or auxiliary accessory that may be connected to the vehicle 202 to drain water from the pool 302. In some aspects, the vehicle power system 244 associated with the vehicle 202 may be configured to provide or supply power to the motor 304 to draw water from the pool 302.

In some aspects, the user 125 may be configured to transmit an instruction or a request remotely via the mobile device 212 to the transceiver 246 to control the vehicle power system 244 when the motor 304 may be drawing water from the pool 302. For example, the user 125 may remotely transmit a request, via the mobile device 212, to deactivate the vehicle power system 244 when the motor may be drawing water from the pool 302. Responsive to receiving the request, the transceiver 246 may send the request to the processor 248. The processor 248 may obtain the request and deactivate the vehicle power system 244 responsive to obtaining the request. Thus, the user 125 may access and control the vehicle power system 244 (and thus accessory 110 operation) remotely by using the mobile device 212 and the power management system 208.

In further aspects, the transceiver 246 may be configured to receive real-time vehicle power system usage, battery level, etc. from the vehicle sensory system 234 (e.g., the vehicle external power usage sensors), and may transmit the real-time vehicle power system usage, battery level, etc. to the mobile device 212 and/or the server 220 for monitoring purposes. The user 125 may monitor vehicle power system usage in real-time, battery level, etc. via the mobile device 212. Based on the monitoring, the user 125 may transmit a request to deactivate the vehicle power system 244 or limit the discharge rate via the mobile device 212. The transceiver 246 may receive such request and send the request to the processor 248. The processor 248 may obtain the request and deactivate the vehicle power system 244 or limit the discharge rate responsive to obtaining the request. In some aspects, the processor 248 may be configured to indicate to the user 125 that the vehicle power system 244 may be deactivated via a vehicle speaker system (e.g., an exterior sound exciter), a vehicle-to-phone communication, or the infotainment system 240.

In further aspects, the processor 248 may be configured to obtain user inputs associated with vehicle power system usage or operation via the transceiver 246. In this case, the user 125 may transmit the user inputs via the mobile device 212 to the transceiver 246, and the transceiver 246 may send the user inputs to the memory 250 for storage purpose and/or directly to the processor 248. When the user inputs are stored in the memory 250, the processor 248 may be configured to obtain the user inputs from the memory 250.

The processor 248 may control the vehicle power system usage or operation based on the user inputs. As described above, the user inputs may include rule sets to control the vehicle power system operation, which may ensure that the vehicle power system 244 may not be misused.

As an example of a rule set described above, the user 125 may set a timer in the vehicle 202 to deactivate the vehicle power system 244 after a predefined time duration of usage. In this case, when (or after) the user 125 activates the vehicle power system 244 (e.g., to draw water from the pool 302 by using the motor 304), the user 125 may set, via the mobile device 212, a time duration after which the power management system 208 may deactivate the vehicle power system 244. For instance, the user 125 may set the timer of 15 minutes to deactivate the vehicle power system 244. In this case, the processor 248 may deactivate the vehicle power system 244 after 15 minutes based on the rule set (e.g., the time duration of usage) obtained from the mobile device 212.

As another example of the rule set, the user 12 may set a threshold energy consumption value for the vehicle power system 244. For example, the user 125 may set, via the mobile device 212, a threshold energy consumption value of 5 KW to deactivate the vehicle power system 244. In this case, the processor 248 may deactivate the vehicle power system 244 when the motor 304 draws 5 KW power from the vehicle power system 244.

As yet another example of the rule set, the user 125 may set a timer to activate the vehicle power system 244 between a first timestamp and a second timestamp. For example, the user 125 may set, via the mobile device 212, a timer to activate the vehicle power system 244 in allowed hours of operation such as between 9 AM (i.e., the first timestamp) to 5 PM (i.e., the second timestamp). In this case, the processor 248 may activate the vehicle power system 244 between 9 AM and 5 PM.

As another example of the rule set, the user 125 may define or indicate, via the mobile device 212, a geo-fenced area in which the vehicle power system 244 may be activated. For example, the user 125 may authorize the vehicle power system 244 to be activated only when the vehicle 202 may be located in a work location. In this case, the processor 248 may obtain real-time vehicle geolocation from the TCU 228 and may activate the vehicle power system 244 when the vehicle 202 may be located in the work location and/or may not activate the vehicle power system 244 when the vehicle 202 may be located at any other location.

As described above, the processor 248 may be configured to obtain the user inputs/rule sets from the memory 250 and/or the mobile device 212, and configured to control the vehicle power system 244 operation (such as activating/deactivating/limiting discharge rate of the vehicle power system 244) based on the user inputs/rule sets.

As another example of the rule set, the user 125 may set, via the mobile device 212, a threshold value associated with a State of Charge (SoC) associated with the battery 242 below which the vehicle power system 244 may not operate. For example, the user 125 may provide a rule set to deactivate the vehicle power system 244 when the SoC may be less than 30%. In this case, the processor 248 may obtain real-time SoC level associated with the battery 242 from the VCU 206 and determine that the real-time SoC may be less than the threshold value. Responsive to such determination, the processor 248 may deactivate the vehicle power system 244.

In further aspects, the processor 248 may be configured to obtain inputs from the vehicle sensory system 234, for example, when the vehicle power system 244 may be operational or providing power to an external accessory (e.g., the motor 304). In some aspects, the processor 248 may obtain the inputs from the vehicle sensory system 234 (such as vehicle exterior cameras) at a predetermined frequency via the transceiver 246. The processor 248 may be configured to monitor the vehicle power system usage based on the obtained inputs from the vehicle sensory system 234 and determine if the vehicle power system 244 may be used in an expected or authorized manner.

For example, the processor 248 may obtain inputs from the vehicle exterior cameras and determine whether the vehicle power system 244 may be used by an authorized user (such as the user 125 or fleet employees). Specifically, the processor 248 may compare images of a user using the vehicle power system 244 as obtained from the vehicle exterior cameras with pre-stored images of authorized users (that may be pre-stored in the memory 250). The processor 248 may determine that an authorized user may be using the vehicle power system 244 based on the comparison. For example, when the user image obtained from the vehicle external cameras matches with at least one pre-stored image of authorized users, the processor 248 may determine that the user using the vehicle power system 244 may be an authorized user. On the other hand, the processor 248 may determine the user to be an unauthorized user if the images do not match.

The processor 248 may be configured to control vehicle power system usage/operation based on the determination of authorization of users. For example, the processor 248 may deactivate the vehicle power system 244 when an unauthorized user may be using the vehicle power system 244.

In further aspects, the processor 248 may be configured to automatically pre-authorize vehicle power system usage and may obtain and store inputs from the vehicle exterior cameras in the server 220 or in the memory 250. In further aspects, the processor 248 may authorize vehicle power system usage when more than one person may be located in proximity to the vehicle 202 (as determined using the vehicle sensory system 234), which may reduce likelihood of misuse.

FIG. 4 depicts another example of an embodiment to control the vehicle power system 244 operation in accordance with the present disclosure. In some aspects, the user 125 may enable or allow other users or third party (e.g., whose images may not be pre-stored in the memory 250) to use the vehicle power system 244, for example, when the user 125 may be away from the vehicle 202. In such scenarios, the vehicle 202 may indicate that the vehicle power system 244 may be configured to (or open to) receive requests to power accessories (including the accessory 110) from other users. Such indications may include, for example, vehicle light blinking, audio signal output from vehicle speakers, and/or the like.

In this case, when a user/third party desires to the power an accessory, the user may send a request, via a user device associated with the user, to the transceiver 246 to use the vehicle power system 244. The transceiver 246 may receive the request via the network 214 and may send the request to the processor 248. In other aspects, the user may also transmit the request by pressing or activating a “turn on” button/actuator associated with the vehicle power system 244 that may be disposed on the vehicle 202.

In the exemplary aspect depicted in FIG. 4, a user 402 (who may be the “other user” described above) may transmit a user request to the transceiver 246, via a user device 404, to use the vehicle power system 244. The user 402 may be different from the user 125, and thus the user device 404 may be different from the user device 120 or 212. The user request may include at least one of: information associated with an outlet (e.g., the outlet 115) that the user 402 may desire to use, a time duration to use the outlet 115, information associated with the external accessory to be powered, an expected power consumption, etc. and optionally user personal (e.g., user images) and/or contact details.

The processor 248 may obtain the user request from the transceiver 246. Responsive to obtaining the user request, the processor 248 may obtain the user inputs/rule sets from the memory 250. As described above, the user inputs (provided by the user 125) may include rule sets to control the vehicle control system operation/usage. Responsive to obtaining the user inputs, the processor 248 may correlate the user request with the user inputs. The processor 248 may be configured to control the vehicle power system operation based on the correlation.

For example, the user 402 may request to charge the user device 404 for one hour between 4 PM to 5 PM. Responsive to receiving such request, the processor 248 may correlate the request with the user inputs. When the user inputs indicates that the processor 248 may only enable phone charging up to 30 minutes, the processor 248 may deny the user request to charge for one hour. On the other hand, when the user inputs indicate that processor 248 may allow up to 2 hours of phone charging between 9 AM to 5 PM, the processor 248 may accept the user request and may activate the vehicle power system 244 for the user 402 to charge the user device 404. In this manner, the processor 248 may control the vehicle power system operation automatically based on the user inputs that may be pre-stored in the memory 250.

In some aspects, responsive to obtaining the user request, the processor 248 may obtain authorization from the user 125 before enabling the user 402 to use the vehicle power system 244. For example, when the user 402 transmits a request to power a heavy accessory via the vehicle power system 244 and the processor 248 may not determine whether such request may be allowed or enabled (based on the pre-stored user inputs/rule sets), the processor 248 may transmit, via the transceiver 246, a request to the mobile device 212 to obtain authorization from the user 125 on the received user request. The processor 248 may be further configured to obtain the authorization from the mobile device 212 and may control the vehicle power system operation based on the authorization. For example, the processor 248 may activate the vehicle power system 244 when the user 125 accepts the request and may deny the user request (i.e., keep the vehicle power system 244 deactivated) when the user 125 denies the user request.

In further aspects, the processor 248 may be configured to obtain inputs from the vehicle sensory system 234 (specifically the vehicle exterior cameras), for example, when the vehicle power system 244 may be activated based on the user request. In some aspects, the processor 248 may obtain the inputs from the vehicle exterior cameras at a predetermined frequency when the vehicle power system 244 may be activated. The processor 248 may monitor the vehicle power system usage based on the inputs obtained from the vehicle sensory system 234 and determine if the vehicle power system 244 may be used in a manner indicated in the user request or the vehicle power system 244 may be misused. For example, when the user 402 indicates that the user 402 desires to charge the user device 404 via the vehicle power system 244 in the user request, the processor 248 may obtain the inputs from the vehicle exterior cameras and determine whether the user 402 is using the vehicle power system 244 to actually power the user device 404 or any other accessory (such as a compressor). The processor 248 may be configured to control the vehicle power system operation based on such determination. For example, if the user 402 uses the vehicle power system 244 to power the compressor instead of the user device 404 (i.e., improper usage or system misuse), the processor 248 may deactivate the vehicle power system 244.

In further aspects, the processor 248 may be configured to obtain inputs from the TCU 228, for example, when the vehicle power system 244 may be activated based on the user request. Specifically, the processor 248 may be configured to obtain BLE information from the TCU 228 and may estimate accessory location based on the BLE information. The processor 248 may be further configured to determine if the vehicle power system 244 may be used in a manner indicated in the user request based on the estimated accessory location. The processor 248 may be configured to control the vehicle power system operation based on such determination.

In addition, the processor 248 may be configured to characterize accessory (such as user device 404) profile based on actual user device power consumption and expected power consumption (from the user 402 request and/or expected power consumption associated with different accessories that may be pre-stored in the memory 250). The processor 248 may use Artificial Intelligence (AI) or Machine Learning (ML) based techniques or algorithms (that may be stored in the memory 250) to determine whether the user 402 may be improperly using the vehicle power system 244 (i.e., system misuse) based on the characterization and may control the vehicle power system 244 operation accordingly. For example, when the user 402 connects the user device 404 with the vehicle power system 244, the processor 248 may determine an actual power consumption from the vehicle power system 244. The processor 248 may further obtain an expected user device power consumption (that may be pre-stored in the memory 250) and determine a difference between the actual power consumption and the expected user device power consumption. Responsive to determining the difference, the processor 248 may determine whether the user 402 may be improperly using the vehicle power system 244. For example, if the difference may be greater than a predefined threshold, the processor 248 may determine that the user 402 may be improperly using the vehicle power system 244 (e.g., powering any other device different than the user device 404 using the vehicle power system 244).

In further aspects, the processor 248 may be configured to monitor the actual accessory power consumption and may predict accessory maintenance. The processor 248 may be further configured to transmit the prediction to the mobile device 212, the user device 404, or the server 220 so that the accessory may be repaired (if required). Specifically, the processor 248 may transmit the prediction when the actual accessory power consumption may be less (or greater) than a threshold value.

In further aspects, the processor 248 may obtain inputs from the vehicle exterior cameras and determine whether the vehicle power system 244 may be actually used by the user 402 (or any other user) when the vehicle power system 244 may be activated based on the user request obtained from the user 402. Specifically, the processor 248 may use Artificial Intelligence (AI) or Machine Learning (ML) based techniques or algorithms (that may be stored in the memory 250) to compare images obtained from the vehicle exterior cameras with the user 402 image (that may be included in the user 402 request). The processor 248 may determine that the vehicle power system 244 may be used by the user 402 based on the comparison. The processor 248 may be configured to control the vehicle power system operation based on the determination. For example, the processor 248 may deactivate the vehicle power system 244 when the processor 248 determines that the vehicle power system 244 may be used by another user (and not by the user 402) based on the comparison.

In further aspects, the processor 248 may be further configured to estimate a charge associated with the vehicle power system usage responsive to receiving the user request from the user 402/user device 404. In some aspects, the processor 248 may estimate the charge based on the user request and predefined charge rates that may be pre-stored in the memory 250. In this case, the predefined charge rates may be obtained from the user 125 and may be pre-stored in the memory 250. The processor 248 may be configured to transmit the estimated charge to the user device 404 to receive confirmation from the user 402 to proceed with using the vehicle power system 244. The user device 404 may receive the estimated charge from the processor 248 and may provide confirmation to the processor 248. The processor 248 may receive the confirmation from the user device 404 and may activate the vehicle power system 244 for the requested duration based on the received confirmation.

In further aspects, the processor 248 may be configured to transmit the estimated charge to the mobile device 212 to receive authorization on the estimated charge and the user request. The processor 248 may obtain the authorization and may enable the user 402 to use the vehicle power system 244 when the mobile device 212 transmits an authorization signal to the processor 248 (via the transceiver 246 and the network 214).

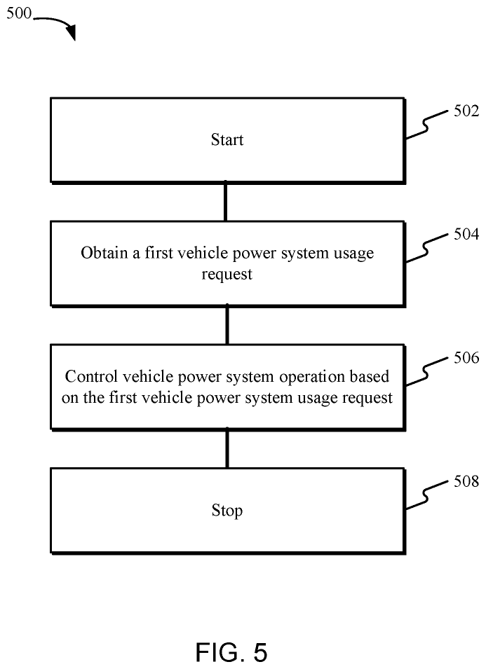

FIG. 5 depicts a flow diagram of an example of a first method 500 to facilitate remote authorization of the vehicle power system 244 in accordance with the present disclosure. FIG. 5 may be described with continued reference to prior figures, including FIGS. 1-4. The following process is exemplary and not confined to the steps described hereafter. Moreover, alternative embodiments may include more or less steps that are shown or described herein and may include these steps in a different order than the order described in the following example embodiments.

The method 500 starts at step 502. At step 504, the method 500 may include obtaining, by the processor 248, a first vehicle power system usage request from the mobile device 212 via the transceiver 246 and the network 214. The processor 248 may obtain the first vehicle power system usage request from the mobile device 212 associated with the user 125, and the first vehicle power system usage request may be to control/use the vehicle power system 244. The first vehicle power system usage request may include at least one of: a request to activate or deactivate the vehicle power system 244, a request to activate or deactivate an outlet associated with the vehicle power system 244, and a request to limit discharge rate associated with the vehicle power system 244.

At step 506, the method 500 may include controlling, by the processor 248, the vehicle power system operation based on the first vehicle power system usage request. For example, when the vehicle power system 244 may be providing power to the motor 304 to drain water from the pool 302, the user 125 may use the mobile device 212 to deactivate the vehicle power system 244 remotely (by transmitting the first vehicle power system usage request) when motor 304 may be drawing water from the pool 302.

The method 500 may end at step 508.

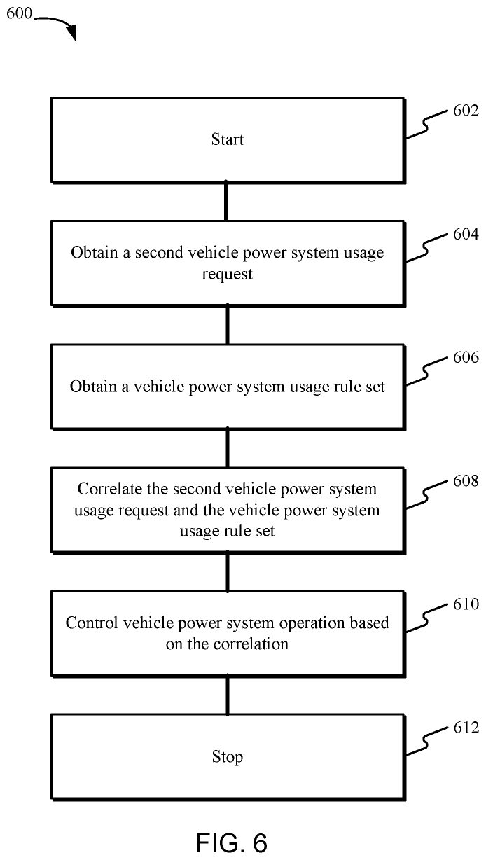

FIG. 6 depicts a flow diagram of an example of a second method 600 to facilitate remote authorization of the vehicle power system 244 in accordance with the present disclosure. FIG. 6 may be described with continued reference to prior figures, including FIGS. 1-5. The following process is exemplary and not confined to the steps described hereafter. Moreover, alternative embodiments may include more or less steps that are shown or described herein and may include these steps in a different order than the order described in the following example embodiments.

The method 600 starts at step 602. At step 604, the method 600 may include obtaining, by the processor 248, a second vehicle power system usage request from a third party user device (e.g., the user device 404 associated with the user 402). The second vehicle power system usage request may include at least one of: information associated with an outlet (e.g., the outlet 115) to be used, a time duration to use the outlet 115, information associated with the external accessory (e.g., the user device 404) to be powered, an expected power consumption, and/or the like.

At step 606, the method 600 may include obtaining, by the processor 248, a vehicle power system usage rule set from the mobile device 212. The vehicle power system usage rule set may include rules/criteria to control the vehicle power system usage/operation. For example, the vehicle power system usage rule set may include at least one of: a rule set to activate the vehicle power system 244 for a predefined time duration, a rule set to activate the vehicle power system 244 between a first timestamp and a second timestamp, a rule set to activate the vehicle power system 244 for a first predefined threshold energy usage value, a rule set to activate the vehicle power system 244 in a vehicle predefined geofenced area, a rule set to limit discharge rate associated with the vehicle power system 244, and a rule set to activate or deactivate an outlet associated with the vehicle power system 244.

At step 608, the method 600 may include correlating, by the processor 248, the second vehicle power system usage request with the vehicle power system usage rule set. Specifically, the processor 248 may correlate the second vehicle power system usage request with the vehicle power system usage rule set and determine whether the processor 248 may approve/accept or deny the second vehicle power system usage request based on the vehicle power system usage rule set provided by the user 125.

At step 610, the method 600 may include controlling, by the processor 248, the vehicle power system operation/usage based on the correlation.

The method 600 may end at step 612.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a battery;
a vehicle power system configured to transfer power from the battery to an external accessory connected to the vehicle power system; and
a processor configured to:
obtain a vehicle power system usage rule set or a first vehicle power system usage request from a first user device associated with a first user to use the vehicle power system; and
control a vehicle power system operation based on the vehicle power system usage rule set or the first vehicle power system usage request.

2. The vehicle of claim 1, wherein the first vehicle power system usage request comprises at least one of: a request to activate or deactivate the vehicle power system, a request to activate or deactivate an outlet associated with the vehicle power system, and a request to limit discharge rate associated with the vehicle power system.

3. The vehicle of claim 1, wherein the vehicle power system usage rule set comprises at least one of: a rule set to activate the vehicle power system for a predefined time duration, a rule set to activate the vehicle power system between a first timestamp and a second timestamp, a rule set to activate the vehicle power system for a first predefined threshold energy usage value, a rule set to activate the vehicle power system in a vehicle predefined geofenced area, a rule set to limit discharge rate associated with the vehicle power system, and a rule set to activate or deactivate an outlet associated with the vehicle power system.

4. The vehicle of claim 1, wherein the processor is further configured to:
obtain an input from a vehicle sensor when the vehicle power system is activated;
monitor a vehicle power system usage based on the input;
determine a vehicle power system improper usage based on the monitoring; and
deactivate the vehicle power system based on a determination of the vehicle power system improper usage.

5. The vehicle of claim 4, wherein the determination of the vehicle power system improper usage comprises determining that the vehicle power system is used by an unauthorized user.

6. The vehicle of claim 1, wherein the processor is further configured to:
obtain a second vehicle power system usage request from a second user device, wherein the second user device is associated with a third party, and wherein the second vehicle power system usage request comprises at least one of: information associated with an outlet to be used, a time duration to use the outlet, information associated with the external accessory to be powered, and an expected power consumption;
correlate the second vehicle power system usage request with the vehicle power system usage rule set; and
control the vehicle power system operation based on the correlation.

7. The vehicle of claim 6, wherein the processor is further configured to:
estimate a charge associated with a vehicle power system usage based on the second vehicle power system usage request and predefined charge rates; and
transmit the estimated charge and the second vehicle power system usage request to the first user device to receive authorization from the first user.

8. The vehicle of claim 7, wherein the processor is further configured to:
obtain the authorization from the first user device; and
control the vehicle power system operation based on the authorization.

9. The vehicle of claim 6, wherein the processor is further configured to:
obtain an additional input from a vehicle sensor when the vehicle power system is activated responsive to obtaining the second vehicle power system usage request;
monitor a vehicle power system usage based on the additional input;
determine a vehicle power system improper usage by the third party based on the monitoring; and
deactivate the vehicle power system based on a determination of the vehicle power system improper usage by the third party.

10. The vehicle of claim 1, wherein the vehicle is further configured to:
obtain a real-time State of Charge (SoC) associated with the battery;
determine that the real-time SoC is less than a threshold value; and
control the vehicle power system operation based on the real-time SoC being less than a threshold value.

11. A method to control vehicle power system of a vehicle, the method comprising:
obtaining, by a processor, a vehicle power system usage rule set or a first vehicle power system usage request from a first user device associated with a first user to use a vehicle power system, via a wireless communication network, wherein the vehicle power system is configured to transfer power from a vehicle battery to an external accessory connected to the vehicle power system; and
controlling, by the processor, a vehicle power system operation based on the vehicle power system usage rule set or the first vehicle power system usage request.

12. The method of claim 11, wherein the first vehicle power system usage request comprises at least one of: a request to activate or deactivate the vehicle power system, a request to activate or deactivate an outlet associated with the vehicle power system, and a request to limit discharge rate associated with the vehicle power system.

13. The method of claim 11, wherein the vehicle power system usage rule set comprises at least one of: a rule set to activate the vehicle power system for a predefined time duration, a rule set to activate the vehicle power system between a first timestamp and a second timestamp, a rule set to activate the vehicle power system for a first predefined threshold energy usage value, a rule set to activate the vehicle power system in a vehicle predefined geofenced area, a rule set to limit discharge rate associated with the vehicle power system, and a rule set to activate or deactivate an outlet associated with the vehicle power system.

14. The method of claim 11 further comprising:
obtaining an input from a vehicle sensor when the vehicle power system is activated;
monitoring a vehicle power system usage based on the input;
determining a vehicle power system improper usage based on the monitoring; and
deactivating the vehicle power system based on a determination of the vehicle power system improper usage.

15. The method of claim 14, wherein determining the vehicle power system improper usage comprises determining that the vehicle power system is used by an unauthorized user.

16. The method of claim 11 further comprising:
obtaining a second vehicle power system usage request from a second user device, wherein the second user device is associated with a third party, and wherein the second vehicle power system usage request comprises at least one of: information associated with an outlet to be used, a time duration to use the outlet, information associated with the external accessory to be powered, and an expected power consumption;
correlating the second vehicle power system usage request with the vehicle power system usage rule set; and
controlling the vehicle power system operation based on the correlation.

17. The method of claim 16 further comprising:
estimating a charge associated with a vehicle power system usage based on the second vehicle power system usage request and predefined charge rates; and
transmitting the estimated charge and the second vehicle power system usage request to the first user device to receive authorization from the first user.

18. The method of claim 17 further comprising:
obtaining the authorization from the first user device; and
controlling the vehicle power system operation based on the authorization.

19. The method of claim 17 further comprising:
obtaining an additional input from a vehicle sensor when the vehicle power system is activated responsive to obtaining the second vehicle power system usage request;
monitoring the vehicle power system usage based on the additional input;
determining a vehicle power system improper usage by the third party based on the monitoring; and
deactivating the vehicle power system based on a determination of the vehicle power system improper usage by the third party.

20. A non-transitory computer-readable storage medium having instructions stored thereupon which, when executed by a processor, cause the processor to:
obtain a vehicle power system usage rule set or a first vehicle power system usage request from a first user device associated with a first user to use a vehicle power system, via a wireless communication network, wherein the vehicle power system is configured to transfer power from a vehicle battery to an external accessory connected to the vehicle power system; and
control a vehicle power system operation based on the vehicle power system usage rule set or the first vehicle power system usage request.
